(19) United States
(12) Patent Application Publication
(10) Pub. No.: US 2003/0101346 A1
(43) Pub. Date: May 29, 2003

(54) Method for notarizing receipt of electronic communications and enabling electronic registered mail; method for verifying identity of account party

(76) Inventors: Austin Kesler Barron, Los Angeles, CA (US); Tor Oliver Houghton, Brighton (GB); Simon Sydney Walker, Northwood (GB)

Correspondence Address: Austin Barron, 3642 Clarington Ave. #5, Los Angeles, CA, 90034, US

(21) Appl. No.: 09/795,773

(22) Filed: Feb. 27, 2001

Related U.S. Application Data
(60) Provisional application No. 60/185,635, filed on Feb. 29, 2000.

(51) Int. Cl. H04L 9/00

(52) U.S. Cl. 713/175

(57) ABSTRACT

A notarization method is disclosed whereby two parties can transmit and exchange electronic data without sharing either the data or any proprietary security information with third parties, and whereby the receiving party cannot surreptitiously examine the data without creating a logged record. In a preferred embodiment, the sending party uses an encryption algorithm to encrypt the data package, generating an encrypted copy of the data and a session key that can be used to retrieve the plaintext copy of that data package. The session key is split into two or more discrete subkeys, some or all of which are required to reconstruct the session key, and none of which alone will compromise the other subkeys or the data package. Using secure transport methods, the encrypted data packet and one or more subkeys are delivered to the intended recipient. The remaining subkeys are either retained by the sending party or delivered to a trusted third party using secure transport methods. Using secure and verifiable transport methods, the recipient retrieves the remaining subkeys. This retrieval is logged and an electronic receipt is created documenting the time of retrieval and the identity of the retriever. Once the recipient has sufficient subkeys, it reconstructs the session key and decrypts the data package. The result is similar to a postal system of registered mail, using encryption to replace the security of a human being requiring a physical signature. In an alternate configuration, the system is used to verify the identity of one party for use in applications such as allowing anonymous electronic cash transactions.

### BACKGROUND OF THE INVENTION

1. Field

The invention relates to the transmission of electronic communications in a manner that creates a verifiable log of the receipt of said communications. In an alternate configuration the invention relates to the verification of a party's identity.

2. Brief Description of the Related Prior Art

Electronic communications, while ubiquitous, are still not fully accepted by the business or legal communities. Unlike paper communications and physical delivery systems, there is no reliable electronic system for verifying receipt of an electronic communication. Public electronic networks (such as the internet) do not possess a built-in protocol for receipt verification akin to registered mail, nor is there a protocol that could require a legally verifiable signature for delivery of a data package akin to signing the clipboard when UPS makes a delivery. In short, if time of receipt and verification of receipt are important, paper delivery is required.

This situation arises in any number of business or legal contexts. A bid proposal could state that a company has 20 days from time of receipt to return their bid, or a legal deadline could be configured in the same fashion. Or it could be essential to ensure that a number of recipients all “receive” (i.e. have access to) a data package at the same time. By bifurcating the receipt of the data package from the ability to read its contents, this method also allows the data package to be delivered before the intended time of receipt. Access to the unlocking mechanism can then be made at a specific time. For example, at university, during take-home exams, there is no accurate way to ensure that all individuals get the same amount of time to respond. Students must wait in line for up to an hour to receive the exam and to sign a login sheet verifying receipt of the exam. This system would allow the data package to be delivered before the exam, then at a designated time access to the key would be granted. Unlike a system where the exam itself was made available at a designated time, allowing the key to be available would diminish the load on the server (100 people downloading 100 k-1 meg simultaneously versus 100 people downloading 2 k simultaneously), and would also create an automatic, verifiable record of the download similar to signing the sheet to receive the physical envelope with the exam therein.

This situation is a problem for several reasons. First, this has hampered the acceptance and growth of electronic communications as an acceptable alternative or supplement to traditional paper delivery. Businesses are inhibited from taking full advantage of the ease and efficiency of electronic communications. These benefits are manifest: Electronic communications systems allow the transportation of a large data package around the world literally in seconds. There is no degradation in data quality, the recipient has full access to the data upon receipt (thereby facilitating collaborative projects or allowing transformative uses), and a machine-readable log of the transmissions can be easily generated and saved over time. Another aspect of this problem is that comparable methods of communication with paper can have huge costs. Electronic communications are not only faster, but also incredibly cheaper. This reliance on paper communications creates inefficiencies, maintains barriers to entry for smaller business people, and makes it prohibitive to use instantaneous communications for low value transactions. For example, while a sender may be willing to pay an additional ten or 15 dollars to complete a transaction with a 1000 dollar value, he or she is unlikely to use a 15 dollar method of transaction to complete a two dollar transaction. Finally, these costs are even higher when a data package needs to cross international borders. Customs, transport costs, and sheer geography all conspire to dramatically increase the cost and the time required for delivery when a data package needs to travel internationally. Electronic communications (at present) do not suffer from any such difficulties—it is effectively as cheap and quick to send a message across the globe as across the street.

Although alternatives to pure electronic transmission exist—facsimile is the obvious example—such choices are extremely limited in their usefulness. For example, facsimile allows quicker delivery than traditional couriers, but the data transmission protocol allows transmission at only a fraction of the speed allowed by pure electronic transmission. Furthermore, facsimile is an analog transmission—not only is the picture quality greatly degraded, but the data package cannot be properly manipulated upon receipt. That is, with an electronic message, the data is immediately received in machine-readable and machine-manipulable format. With an analog message, making changes directly to the document requires scanning or inputting the document, complete with the time, effort, and high error rate involved. Similar problems attend traditional paper methods of document transmission.

With all these difficulties, why do companies and legal regimes still use and in fact require paper documents? There are two immediately obvious reasons. One, electronic communications still suffer from the stigma of insecurity. Second, and perhaps more importantly, electronic communications suffer because they do not allow for a return-receipt, or for verifiable delivery, in the same manner as a registered mail system. A sender of an electronic communication is never sure when it was received nor if the intended recipient ever received the message. Should a dispute arise later, the recipient can deny having received the package. There is at this time no signature mechanism, akin to that involved in registered mail or courier service, that serves the dual purpose of verifying the identity of the recipient as well as time of delivery or receipt.

These obstacles may be overcome somewhat by the use of data escrow or key escrow. In these systems, the sender would transmit either the data package or a decryption key to a third party, who would log a transaction with the intended recipient for delivery of these items. However, these systems suffer from a lack of security. The third party has access either to the data package itself or to the means to access the data package. While a physical courier also has access to the data package when in transit, tampering with physical packages is far more easily detected by a recipient. Physical envelopes are used with one-time seals, and any attempt to circumvent those seals is evident. An electronic data package does not carry the same inherent protections against tampering as a physical package and the third party or a conspirator may be able to circumvent the electronic locking mechanism in a manner that would not alert the sender or the recipient. Similarly, if the third party has unrestricted access to the electronic information necessary to unlock a data package, then the data package is vulnerable if the third party or its security is compromised.

These difficulties may be significantly overcome by the use of a method that does not entrust the actual data package nor the complete information necessary to unlock the data package to any party but the sender and the intended recipient. However, if the intended recipient has unrestricted access to both the data package and the information necessary to access the data package, then there is no way to verify that the recipient actually received the data package.

### Benefit of the Present Invention Over Prior Art

It is an object of the present invention to enable a method for allowing two or more parties to transmit secure electronic communications without fear of compromising the integrity of the data package, while simultaneously requiring the recipient of the data package to create a verifiable record that the data package has been received.

In accordance with the present invention, a sender locks the data package away in an electronic “sealed envelope,”¹ that can only be opened with the right key. Unlike real world keys, electronic keys can be duplicated effortlessly, and a ubiquitous key would destroy the security of the envelope. The present invention avoids this problem by splitting the key. That is, rather than making the key freely available, the sender using this invention processes the key and creates one or more discrete subkeys, some two or more of which are required to reconstruct the decryption key. Possession of one subkey does not allow divination of the remaining subkeys. The recipient is sent one or more subkeys, while the others are retained on or transmitted to a secure server; the original key is not transmitted or shared and can conceivably be destroyed. In order to open the sealed envelope containing the data package, a user must retrieve one or more subkeys, creating a logged transaction. In its best embodiment, public key encryption (or any other secure electronic verification system that may be developed (or any of the other systems discussed below)) allows that retrieval and the identity of the retriever to be verified (i.e. the person signing for the key is the individual for whom the key is being held), as well as ensuring ¹ This sealed envelope can take the form of an encrypted copy of the data package, or a pointer to the correct data package, or a key or algorithm for decoding, decyphering, generating, divining or decrypting the data package. For example, a user could define a data package by a string of references to a database, and it would then be this string that would be sealed in the envelope.

that only the intended recipient can actually read and use the retrieved subkey. The result is a secure, logged transaction without the data package or any compromising information having to be shared with any third parties.

In an alternative configuration, the invention allows for the verification of an account party in one or multiple transactions. This method involves an account tied to an account party and overseen by an account administrator. The parties create an account ID and an access code, both of which are required to verify the account holder or to take any action with respect to the account. The access code is split into one or more subkeys, part of which are distributed to the account party. Upon request for verification of the account party or action with respect to the account, such request being accompanied by the account ID and the subparts of the access code, the account administrator reconstructs the access code, verifies the account or identity and/or takes action with respect to the account. In a preferred embodiment, the account administrator then creates a new account ID and/or access code and repeats the process for future verifications. To increase security, multiple iterations of the verification process may be required before any verification is complete or before any action will be allowed with respect to the account.

The basic benefit of the present invention is that no compromising information needs to be shared with third parties. Unlike key escrow, or third party data storage, neither the data nor the any information capable of decrypting the plaintext (opening the sealed envelope) is shared with a third party. The session key is not revealed or transported, nor is it used again until it is reconstructed by the recipient—the original copy can and should be discarded. To reveal the session key, one must have the requisite number of subkeys. The generation process of the subkeys also ensures that possession of fewer than the requisite number of subkeys will not compromise the security of the session key or of the other subkeys.

In addition, because the data package itself is only sent to the intended recipient, and is not compromised or shared with any third parties, only the subkeys are transported over a network and processed by the subkey server facility (whether that be the sender or a third party) when the recipient wants to acknowledge receipt of the data package. This reduces traffic over the network for data packages sent to multiple recipients, reduces processing time at the subkey server, and allows the subkey server to process more requests with reduced infrastructure and investment. This allows for a system that can be installed and utilized with minimal start-up costs.

In the alternative configuration, the benefit of the invention is that compromising information is revealed only when necessary and is thereafter discarded.

By incorporating “secure methods of transport,” the invention is extremely versatile. The subkeys can be transported over public networks, proprietary networks, or out of network (physically mailing a disk or letter with the subkeys, faxing such a document, telephoning the recipient and orally transcribing the subkeys). Such transportation can take any number of secure paths or secure methods. The most obvious is public-key encryption, which carries the added benefit of allowing purely electronic verification of the sender. Other methods allow for secure transport, such as secret splitting (breaking the large data packet into smaller packets that can only be deciphered when all are received) or data explosion (sending a larger data package than necessary or sending more packets than necessary to increase the signal to noise ratio and make it less likely that the transmission will be compromised), and are well documented in the literature on encryption.

Alternately, the parties can avoid transporting the subkeys in the first step altogether. The parties can pre-generate any number of subkeys with a shared reference table. For example, parties A and B each possess the same subkeys, numbered or referenced by name or number or subpart. These pre-set and shared subkeys can be generated any number of ways—during a shared session, during one session after which the generating user transports the entire keyset to the other user(s), by sharing the same input-dependent generation process and mutually agreeing on an input. Secret splitting can be accomplished any number of ways, and the present invention is functional using any of them. The process would then be to generate the initial subkeys by using a pre-defined table or algorithm, and simply reference the method used for generation of the transport subkeys rather than transport them. The remaining receipt subkeys would then be stored on a server and their retrieval logged just as when the transport subkeys are transported.

The subkeys can also be generated in any number of ways. Rather, the secret-splitting/key-splitting can be done in any number of ways. The most obvious is to generate a key of matching length to the session key, and perform Session Key XOR Subkey(1), generating Subkey(2) (or use XNOR). Then Subkeys(1) and (2) become your subkeys. By reversing the process, the original session key can be generated, but only if you possess both subkeys. This split can be done with a bitwise operation like XOR, or with a more complex mathematical algorithm that calculates the resulting subkey by taking the whole of the first subkey as an input. Other methods for splitting a key into several discrete components are well documented in the literature on encryption. The method used to split the session key into two or more subkeys is not important, what is important is that a user needs more than one subkey to reconstruct the session key, and possession of one subkey does not compromise the other subkey or the session key. The keys could also be of differing lengths, and secrecy could be achieved or increased by not releasing the length of the other key or the degree of offset. Mathematical algorithms could also be used to extrapolate or interpolate the result (i.e. S(Km, Kt) yields a Kr that is longer or shorter than Kt).

The stronger or more complex the encryption used to create the session key, the less vulnerable the message will be to a brute force attack (i.e. sequentially or randomly trying key after key after key in an attempt to “guess” the key). The tradeoff is that more complex algorithms create a larger drain on system resources—i.e. it takes longer to en- or de-crypt a message if you use a larger or more complex algorithm, but it geometrically increases security. This creates an added benefit of the present invention over prior art—by taking advantage of distributed processing it practically eliminates any disincentives to using very strong encryption. While an individual sender and recipient can very easily afford to dedicate the extra cycles necessary to increase the encryption strength, a centralized system may not be able to. If the processing of the keys, encrypting or decrypting, is centralized, then one computer must handle multiple requests—by increasing the processing required, the cycles and resources required (as well as the log files, system requirements, etc.) increase as a factor of the number of requests the system must process. The processing must be done—if it is all done in one place as many current systems require, the process will suffer in efficiency. If the processing is distributed among a number of systems (requiring each user to dedicate the necessary cycles), then the process as a whole gains in efficiency and quickness.

An alternative configuration allows applications such as use in electronic money. Here, the parties would be an electronic money vendor, an electronic money customer, and a retailer or other payee. The customer would approach the vendor, create an account, and deposit a sum of money. The vendor or the customer would create an account ID and an account password or key of sufficient length to ensure security. The account password would be “split,” one subkey would be held by the customer, one subkey would be held by the vendor. Neither party need possess the whole key. When a customer wanted to make a purchase or transfer value to the payee, it would transmit the account ID and the subkey to the payee, who would then transmit that account ID and subkey to the electronic money vendor along with the payment information (i.e. who is getting paid and how much). The vendor would recombine the subkeys and open the account—if the account opens, then the transaction is validated, recorded and executed. The vendor would receive only confirmation of the transaction. (Alternately, the customer could transmit the subkey to the vendor with the payment information and information on where to send transaction confirmation.) Meanwhile, the vendor would create a new account password, re-split it, retain one subkey, and transmit the second subkey to the original customer using a secure method of transport. Each time the account is accessed the password would be changed, increasing the security of the account. The subkey would be transmitted securely to the same party who set up the account (accessed from the records on the account)—thus if the subkey were compromised, it would at most allow the thief to execute one fraudulent transaction. Security could be enhanced by requiring asymmetric encryption—the subkey would be transported to the customer encrypted to his public key, but would need to be signed by his secret key in order to verify the transaction. This configuration of the method also allows for purely anonymous transactions—the only identification needed would be a public-private keypair. The basic benefit of this configuration is to allow verification of a statement or an account party over multiple sessions, where compromise of the delicate information in one session does not compromise the security of future sessions. This algorithm basically works to verify a statement or a transaction, and would thus also work well in other situations where a third party would need to verify such information, such as identity checks.

### DESCRIPTION OF THE PREFERRED EMBODIMENT

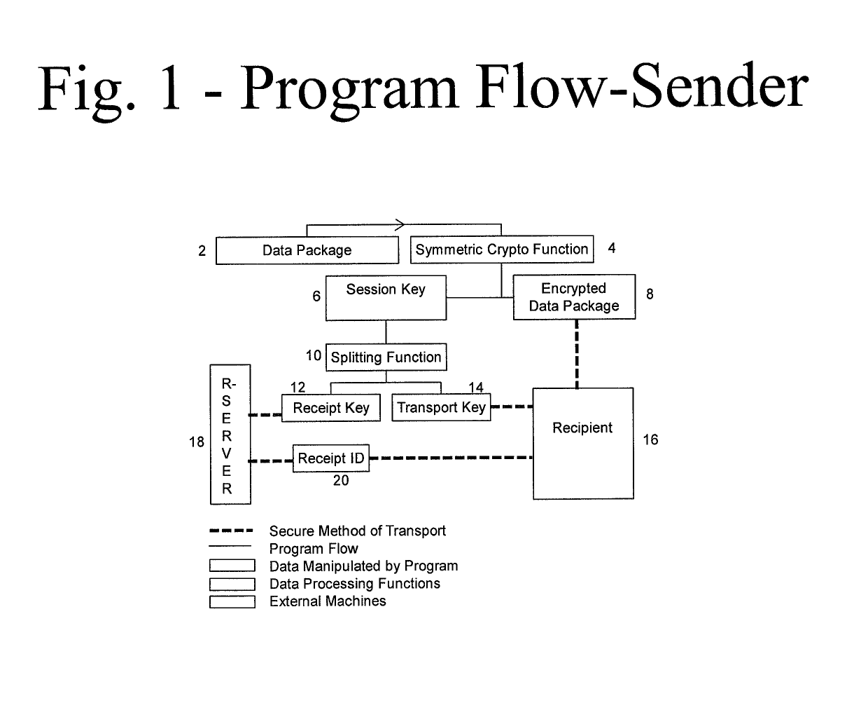

FIG. 1 shows the overall view of preferred embodiment of the present invention. The sender takes a data package (2), passes it through a symmetric cryptographic function (4), yielding a session key (decryption key) (6) and an encrypted data package (8). The session key (6) is passed through a splitting function (10), yielding two or more subkeys, divided into subsets of receipt subkeys (12) and transport subkeys (14). The transport subkeys (14) and the encrypted data package (8) are transmitted to the intended recipient (16) via secure methods of transport. The receipt subkeys (12) are transmitted via secure methods of transport to the receipt server (18). Upon request from the recipient over secure channels, including the receipt ID or other referent (20), which enables the receipt server to determine which data package is required, the receipt server transmits the receipt subkeys (12) to the intended recipient (16), who is then in possession of the information necessary to access the data package (2).

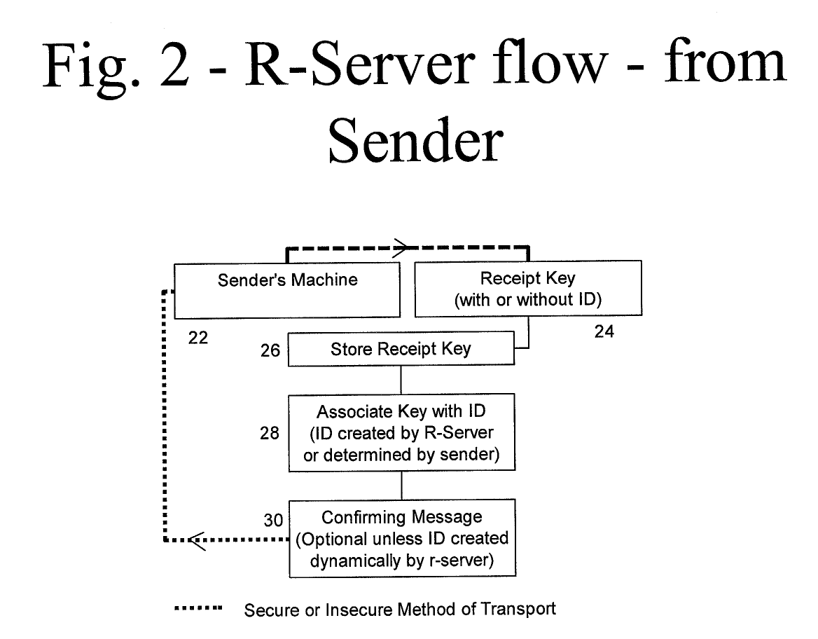

FIG. 2 shows one possible method for the transmission of the receipt subkeys to the receipt server and the association of the receipt key with a receipt ID. As indicated, there are multiple methods for creating the association. Creation of a unique receipt ID is only necessary if the receipt server will be processing multiple requests.

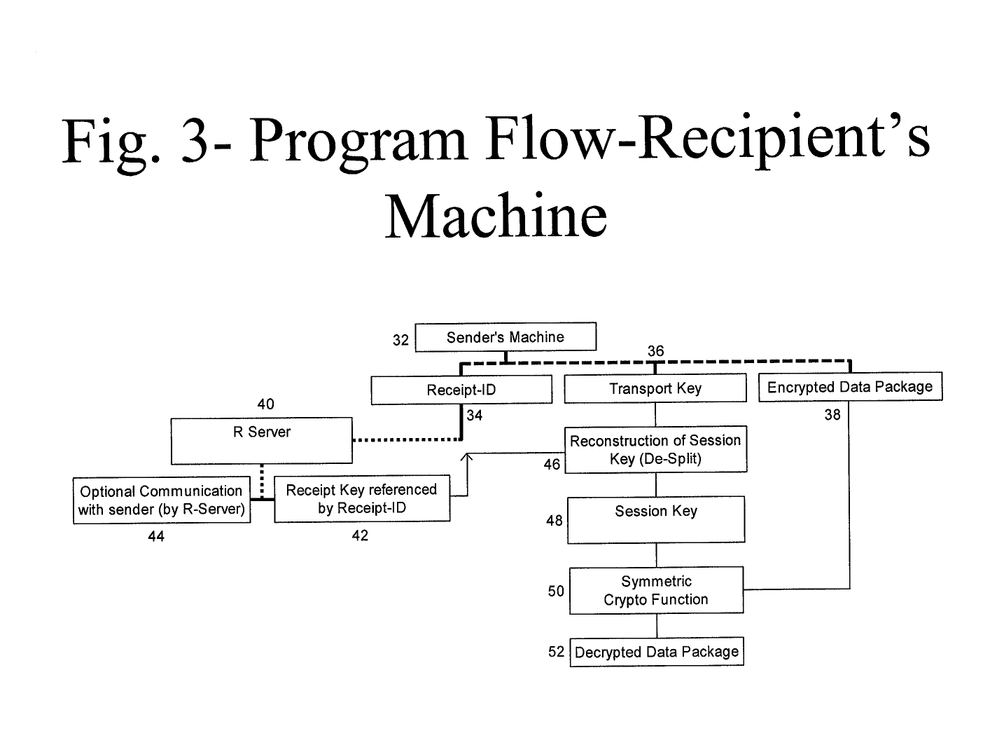

FIG. 3 shows the program flow from the perspective of the intended recipient. The intended recipient receives from the sender (32) the receipt ID (34), the transport subkeys (36) and the encrypted data package (38). The intended recipient transmits the receipt ID (34) to the receipt server (40) via a signed, secure communication, and is returned the receipt subkeys (42). Optionally, the receipt server may send a verifying communication (44) to the sender. The intended recipient takes the receipt subkeys (42) as received from the receipt server (40), combines them with the transport subkeys (36) received from the sender (32) and reconstucts (46) the session key (48). The session key (48) is then used to decrypt (50) the encrypted data package (38), yielding the decrypted plaintext of the message (52).

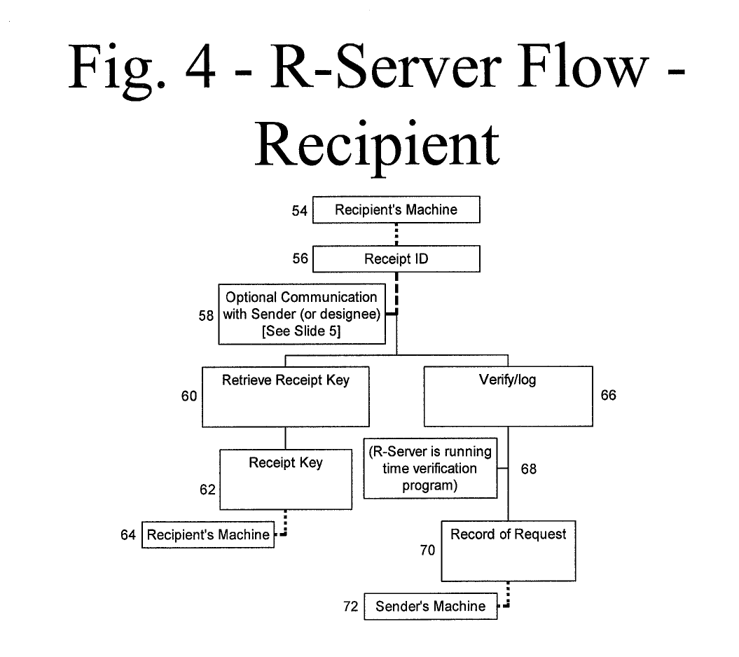

FIG. 4 shows the program flow from the perspective of the receipt server upon receipt of the request from the intended recipient, showing the retrieval of the receipt subkeys from its storage area (60) and transmission of the receipt key (62) to the intended recipient (64). In the preferred embodiment, the receipt server not only logs the fact of the request and the identity of the requestor (66), but also has access to a trusted time verification source (68) which it uses to create a trusted time stamp on the record of the request (70). Optionally, the record is then automatically transmitted to the sender (72).

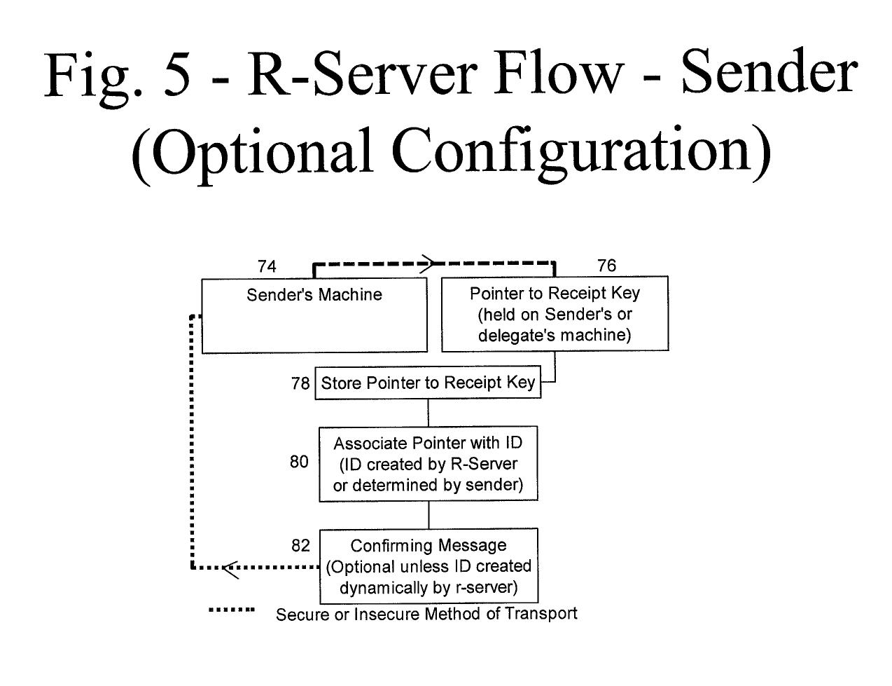

FIG. 5 shows an alternate embodiment wherein the receipt server does not receive the receipt subkeys (12) from the sender but only a pointer (76) to the receipt subkeys held by the sender (74). Upon receipt of the request from the intended recipient (not shown), the receipt server then either (i) sends a confirming message to the sender (82) who then transmits the receipt subkeys to the intended recipients (not shown) or (ii) or retrieves the receipt subkeys from the sender and transmits them to the intended recipient (not shown).

The present invention can be embodied in a system with hardware and/or software components. Forming the session key is almost certainly a process best embodied in software. Several commercial products or processes are available for this simple step, including publicly available encryption algorithms. Another possibility is to license the use of a proprietary algorithm to increase the security of the encryption method. As mentioned above, the effectiveness of the process is decreased if the encryption used at this point is too weak, since the message will be vulnerable to a brute force attack.

The key-splitting process can be embodied in software or hardware or a combination thereof. A simple bit-wise operation, like the XOR or XNOR, transforms the data, and can be as simple as a command-line operation or as complex as a specialized microchip. (XOR is a simple logical

What we claim is:

1. A method for enabling the electronic notarization of the receipt of electronic communications or for enabling an electronic registered mail system, comprising the steps of:
encrypting an information packet;
splitting the decryption key for the encrypted information packet into two or more subkeys, all of which are necessary to reconstruct the decryption key;
transmitting the encrypted information packet to the intended recipient;
transmitting some number of the subkeys greater than zero but fewer than will enable reconstruction of the decryption key to the intended recipient of the information packet;
transmitting the remaining subkeys to one or more third parties;
upon request from the intended recipient to the third party or parties, transmission by the third party or parties to the recipient of the remaining subkeys;
logging of the request and transmission by the third party or parties;
reconstruction of the decryption information by the recipient; and
decryption of the information packet.

2. The method as described in claim 1 wherein the information packet is not the intended message but is a packet of information enabling the intended recipient to access the intended message.

3. The method as described in claims 1 or 2 wherein some or all of the transmissions take place using secure methods of communication, including the use of symmetric or asymmetric encryption, the use of secure or proprietary channels, pre-selection of encryption keys or out-of-network communication.

4. The method as described in claim 1, 2, or 3 wherein the intended recipient transmits its subkey(s) to the third party or parties and the step of reconstructing the decryption key is performed by some or all of the third party or parties, who transmit(s) the reconstructed decryption key to the intended recipient.

5. The method as described in claims 1, 2, 3, or 4 wherein some or all of the set of subkeys not transmitted to the intended recipient are not transmitted to a third party or parties but are instead retained by the sender, who in all respects replaces that third party in the remaining steps.

6. The method as described in claims 1, 2, 3, 4 or 5 wherein some one or all of the set of subkeys not transmitted to the intended recipient is not transmitted to a third party or parties but is instead retained by the sender, wherein, upon request from the intended recipient, one or more third parties informs the sender of the request, wherein the sender then in all respects replaces a third party in the remaining steps.

7. The method as described in claims 1, 2, 3, 4, 5, or 6 wherein some subset greater than one but fewer than all of the subkeys are necessary to reconstruct the decryption key.

8. The method as described in claims 1, 2, 3, 4, 5, 6, or 7 wherein the transmission to the intended recipient takes place not upon request from the intended recipient but upon the happening of some predetermined event.

9. The method as described in claims 1, 2, 3, 4, 5, 6, 7, or 8 wherein one or more of the subkeys is predetermined and therefore need not be transmitted.

10. The method as described in claims 1, 2, 3, 4, 5, 6, 7, 8, or 9 wherein one or more of the communications is digitally signed by the transmitting party.

11. The method as described in claims 1, 2, 3, 4, 5, 6, 7, 8, 9, or 10 wherein the sender transmits to the third party or parties a pointer or pointers or a referent or referents to one or more of the subkeys not transmitted to the intended recipient.

12. The method as described in claims 1, 2, 3, 4, 5, 6, 7, 8, 9, 10, or 11 with the additional steps of creating a unique identification data package, associating that identification package with the data package being transmitted, and requiring the inclusion of the identification data package with the request for the subkeys not transmitted to the intended recipient.

13. A method for enabling secure electronic verification of a account party's or account parties' identity by means of account access data packages, wherein there is an account administrator who holds or administers an account for an account party or parties, and wherein there is an account with an account reference data package and an account access data package, both of which are necessary to access the account or take any action with respect to the account, comprising the following steps:
splitting the account access data package into two or more subkeys, all of which are necessary to reconstruct the account access data package;
transmitting the account reference data package to the account party or parties;
transmitting some number greater than zero but fewer than all of the subkeys to the account party or among the account parties;
retaining in the possession of the account administrator the subkeys not transmitted to the account party or parties;
transmission from a third party of a request for verification of the account party's or account parties' identity, such request containing the account reference data package and some one or all of the subkeys previously transmitted to the account party or parties by the account administrator;
reconstruction and verification of the account access data package by the account administrator; and
transmission of the verification to the third party.

14. A method based on the method in claim 13, wherein some number greater than one but fewer than all of the subkeys are necessary to reconstruct the account access data package.

15. A method based on the method in claims 13 or 14, wherein the account access data package is not split into subkeys but is transmitted to the account party.

16. The method as described in claims 13, 14, or 15 wherein some or all of the transmissions take place using secure methods of communication, including the use of symmetric or asymmetric encryption, the use of secure or proprietary channels, pre-selection of encryption keys or out-of-network communication.

17. A method based on the method in claims 13, 14, 15, or 16 wherein the request for verification originates from the account party.

18. A method based on the method in claims 13, 14, 15, 16, or 17 with the additional step of, after verification of the account by the account administrator, destroying or invalidating the previously-used account reference data package and/or the previously used account access data package, then repeating the steps comprising the method in claim 1 with the creation of a new account reference data package.

19. A method based on the method in claim 18 wherein some number of verifications greater than one is required for verification.

20. A method based on the method in claims 13, 14, 15, 16, 17, or 18 wherein the request for verification is accompanied by a request from the third party for the account administrator to take certain actions, which actions will be carried out upon verification by the account administrator.

21. A method based on the method in claims 13, 14, 15, 15, 17, 18, 19 or 20 wherein the request for verification is accompanied by a request from the account party for the account administrator to take certain actions, which actions will be carried out upon verification by the account administrator.
